(19) United States
(12) Patent Application Publication
(10) Pub. No.: US 2025/0015538 A1
(43) Pub. Date: Jan. 9, 2025

(54) ASSEMBLY FOR A CONNECTOR

(71) Applicant: TE Connectivity India Private Limited, Bangalore (IN)

(72) Inventors: Attad VISHWANATH, Bangalore (IN); Amith Manjunath B, Bangalore (IN)

(21) Appl. No.: 18/754,818

(22) Filed: Jun. 26, 2024

(30) Foreign Application Priority Data
Jul. 6, 2023 (IN) 202341045378

(51) Int. Cl. H01R 13/629; H01R 13/64

(52) U.S. Cl. CPC H01R 13/62955; H01R 13/64

(57) ABSTRACT

An assembly for a connector includes a housing part, a cover adapted to be mounted to the housing part, a lever that is adapted to be attached to the housing part and that can be rotated from a starting position to a final position relative to the housing part when attached, a lever lock that blocks the rotation of the lever out of the final position when the lever lock is in a locking position, and that allows a rotation of the lever when the lever lock is in a release position, wherein the lever lock can only be moved from the release position to the locking position when the lever is in the final position and the cover is mounted on the housing part.

### CROSS REFERENCE TO RELATED APPLICATIONS

This application claims the benefit of IN Application No. 202341045378, filed 6 Jul. 2023, the subject matter of which is herein incorporated by reference in its entirety.

### BACKGROUND OF THE INVENTION

The subject matter herein relates to an assembly for a connector.

Connectors can comprise various parts, for example a housing part, a cover that can be mounted on the housing part, and/or a lever for securing and/or moving the connector to a mating connector.

A problem associated with previous connectors is that care has to be taken when mounting the parts to avoid incorrect and possibly hazardous assembly.

An object of the subject matter herein is to provide a solution that makes the production and the assembly easier and less error-prone.

### BRIEF DESCRIPTION OF THE INVENTION

In one embodiment, an assembly for a connector is provided including a housing part, a cover adapted to be mounted to the housing part, a lever that is adapted to be attached to the housing part and that can be rotated from a starting position to a final position relative to the housing part when attached, a lever lock that blocks the rotation of the lever out of the final position when the lever lock is in a locking position, and that allows a rotation of the lever when the lever lock is in a release position, wherein the lever lock can only be moved from the release position to the locking position when the lever is in the final position and the cover is mounted on the housing part.

The fact that the lever lock can only be moved from the release position to the locking position when both conditions are met, namely when the lever is in the final position and the cover is mounted on the housing part, makes production easier as the correct mounting state does not need to be checked manually.

Solutions according to the subject matter herein can be improved by the following further developments and advantageous embodiments, which are independent of each other and can be combined arbitrarily, as desired.

In a simple and reliable solution, a movement of the lever lock out of the release position and/or into the locking position can be blocked by a pair of engaging translational blocking members on the lever and the lever lock, respectively. In particular, the translational blocking members engage when the lever is not in the final position and/or the cover is not mounted on the housing part. In the desired correctly assembled state, i.e., when the lever is in the final position and the cover is mounted on the housing part, the engagement or blocking effect can be lifted or canceled. The pair of translational blocking members then are disengaged, at least relating to a movement of the lever lock from the release position to the locking position.

A movement from the locking position back to the release position can be blocked or free in the correctly assembled state. For example, it could be necessary to unblock a further mechanism to leave the locking position. The further mechanism can be an automatically engaging mechanism, e.g. a latching mechanism that creates a positive fit when the lever lock is moved from the release position to the locking position. This can avoid an unintentional release of the connector and thus increases safety further.

In an advantageous embodiment, the cover can comprise a release element for disengaging the two translational blocking members when the lever is in the final position and the cover is mounted on the housing part. The release element can be a part or a section of the cover. It can be integral or one-piece with the rest of the cover. The cover can be a single piece preferably made of a uniform material.

The release element can comprise or be a protrusion. The protrusion can protrude from a surrounding planar area and/or the rest of the cover.

The protrusion can protrude outwardly, at least components thereof. “Outwardly” can be understood as meaning away from a center of gravity of the cover and/or the connector.

In other embodiments, the protrusion can protrude inwardly or protrude in a tangential or circumferential direction.

The release element can be elongated, for example to allow an easy assembly while keeping the material and space requirements low. It can be elongated along a mounting direction of the cover, i.e. a direction along which the cover is mounted onto the housing part.

To simplify the assembly further, the release element can be elongated in a connection direction of the connector. The connection direction of the connector can be parallel to the mounting direction of the cover. With this solution, the assembly is simple. The force flow during assembly is along the same direction and thus advantageous. The connection direction is to be understood as the direction along which the connector is mated with the mating connector, for example a header.

The cover can comprise at least one further release element. In an advantageous development, a further release element is equivalent to the (first) release element when the cover is mounted to the housing part in a 180° rotated position. This allows the use of the cover in different applications, for example if the cover defines an outlet for cables. The cover can then be attached in two different orientations resulting in different locations and/or orientations of the outlet. To balance the force flow, the first release element and at least one further release element are mirror symmetrically arranged on the cover.

In one possible embodiment, the translational blocking member of the lever lock is located at a free end of the lever lock. A stop face can be an outermost face or front face of the lever lock. Such a configuration can save space.

Several sequences for mounting the cover and operating the lever can be possible.

In one development, the cover can be mounted when the lever is in the final position. This can be advantageous, as the mounting of the cover may be easier when the lever is no longer in the way.

In a further development, the lever can be moved into the final position when the cover is mounted. This may be advantageous if, for example due to safety regulations, it should be avoided that the connector is mated with the mating connector without the cover being mounted.

The assembly can allow only one of the two sequences. The other may be excluded by suitable means like blocking members or the like.

However, to make the assembly easy for the operator, both sequences may be possible.

In order to safeguard correct assembly and in particular to assure that the lever is in the final position when the lever lock is moved, a movement of the lever lock into the locking position may be blocked by a further pair of engaging translational blocking members on the lever and the housing part, respectively, when the lever is close to but not in the final position. A movement is then not possible if both the cover and the lever are close to but not in their desired position, namely the final position for the lever and a correctly mounted position for the cover. The further pair should of course not block the movement of the lever lock when the lever is in the final position.

The further pair can, in particular, be spaced from the first pair in a radial direction. The radial direction can relate to a rotation axis about which the lever rotates relative to the housing part.

As for the other positions, the final position is not to be understood in a strict mathematical sense as a single position but rather as a small range of positions. This allows for manufacturing and assembling tolerances and movements. For example, the starting position and the final position can relate to a range of less than 5 degrees, preferably less than 3 degrees, and especially less than 1 degree. Similarly, the release position and the locking position can relate to a range of less than 3 mm, preferably less than 1 mm, and especially less than 0.1 mm in the case that the lever lock is moved in a translational manner. However, the lever lock could also be moved in a rotational manner or in a mixed manner. In a broader sense, any position outside the final position can be considered a starting position and/or any position outside the release position can be considered a locking position.

The range of “close to” can be defined as a range of 5 degrees, 10 degrees or 20 degrees adjacent to the (range of the) final position.

In particular, the blocking by the further pair can be independent of the status of the cover, i.e. mounted or not mounted to the housing part.

In one embodiment, the lever lock is slidable relative to the lever when attached thereto. This can allow a simple and safe operation. The lever and/or the lever lock can comprise guiding elements like rails, tracks, pins and/or slits that are compatible or complementary to each other.

According to one development, a distance of the lever lock to the rotation axis of the lever is shorter in the locking position than in the release position. This can make the connector more compact. The two can, for example, be connected in a telescoping manner.

A distance of the lever lock to the rotation axis of the lever may be constant during the rotation of the lever relative to the housing part. During the entire rotation, the lever lock can be in the release position.

In order to increase the lever force, the lever lock can act as an extension part for the lever when in the release position. For example, a radially outer end or distal end of the lever lock can be further away from the rotation axis of the lever than a radially outer end or distal end of the lever. For example, the difference can be at least 10%, preferably at least 20%. The difference can be smaller or almost zero when the lever lock is in the locking position.

The lever lock can comprise an actuation section adapted for an actuation of the combination of the lever and the lever lock by a user or a machine. For example, the actuation section can comprise actuation faces that are substantially perpendicular to a path of the actuation section during the rotation of the lever. The configuration can be such that an operation by a test hand or test finger is possible. The test hand or test finger can be defined in norms or standards that can be set nationally, internationally, by a company or by a consortium.

The lever lock and the housing part can comprise a pair of engaging rotational blocking members for blocking a rotation of the lever out of the final position when the lever lock is in the locking position. The blocking is thus indirectly with at least the lever lock as an intermediate element.

In one embodiment, the lever lock can comprise a blocking member that forms one of the further pair of engaging translational blocking members and one of the engaging rotational blocking members. This blocking member thus has a double function and reduces the complexity of the connector.

The blocking member can have different shapes. It can be formed as a protrusion, a web, a pin, or a collar.

To further increase the safety and, in particular, to secure the lever in the final position when the lever lock cannot yet be moved into the locking position, the assembly may comprise a further, second lever lock for blocking a movement of the lever out of the final position.

This second lever lock can be closer to the axis of rotation to keep the space requirements at a minimum. As the second lever lock is mainly used when the connector is not yet mated with the mating connector and the forces are thus lower, a location closer to the rotational axis can suffice for securing at this stage.

In one embodiment, the second lever lock can be moved in a translational manner. For example, the second lever lock can be adapted to be operated along a direction parallel to the rotation axis. The operation of such a second lever lock may lead to little interference with other assembling, mounting and/or mating operations. The second or further lever lock can be held slidable parallel to the rotation axis in the housing part.

The second lever lock can be separate and/or independent from the first lever lock.

In one advantageous embodiment, the further lever lock can be adapted to block mating of the connector with a mating connector when in a locking position. Such a double function can reduce the complexity. To achieve such a blocking, the further lever lock can, for example, protrude from the housing part in the locking position.

The lever and the lever lock can be separate elements. They can be made from different materials, depending on the application. Each of the lever, the lever lock, the housing part and the second lever lock, if present, can be a single monolithic piece to keep the design simple.

The connector can comprise further parts, for example terminals, terminal blocks, further housing parts and/or further covers or cover parts.

The housing part can form receptacles for the terminals or terminal blocks. In other embodiments, the receptacles can be located in a further housing part of the connector.

The further lever lock can be adapted to lock the terminals or terminal blocks in the part that forms the receptacles, for example the housing part. Such an additional function increases the safety, while keeping the complexity at a reasonable level. The terminals or terminal blocks can block a movement of the further lever lock when they are incorrectly or insufficiently inserted.

The lever may be part of a securing mechanism for securing the connector to the mating connector.

In one embodiment, mating of the connector with the mating connector is only possible when the lever is in the starting position.

In addition or alternatively, the lever can be part of a pulling mechanism for pulling the connector to the mating connector. The connector in particular, can comprise a gear system for transmitting or adapting the force to the application.

Each one of the starting position and the final position can be an end position of the rotation. The end positions can be defined by stop faces on the lever and/or the housing part.

### BRIEF DESCRIPTION OF THE DRAWINGS

The invention will now be described in greater detail and in an exemplary manner using advantageous embodiments as well as with reference to the drawings. The described embodiments are only possible configurations, in which the individual features as described above can be provided independently of one another or can be omitted. In the figures:

FIG. 1 shows a schematic perspective view of parts of an embodiment of a housing assembly with a lever in a final position and a lever lock in a release position;

FIG. 2 shows a schematic perspective view of the embodiment of FIG. 1 together with a cover mounted correctly on the housing part, the lever being in the starting position and the lever lock being in the release position;

FIG. 3 shows a schematic perspective view of the embodiments of FIGS. 1 and 2 with the cover being mounted correctly, the lever being in the final position and the lever lock being in the locking position;

FIG. 4 shows a schematic, partially sectional top view of the embodiments of FIGS. 1 to 3;

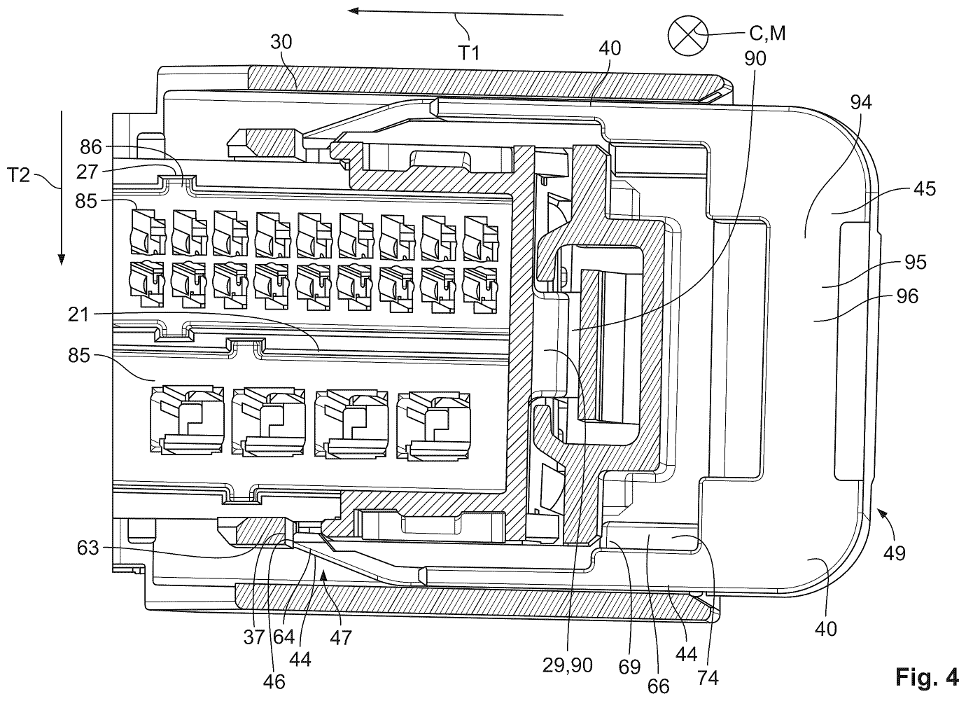

FIG. 5 shows a schematic, partially sectional side view of the embodiments of FIGS. 1 to 4; and

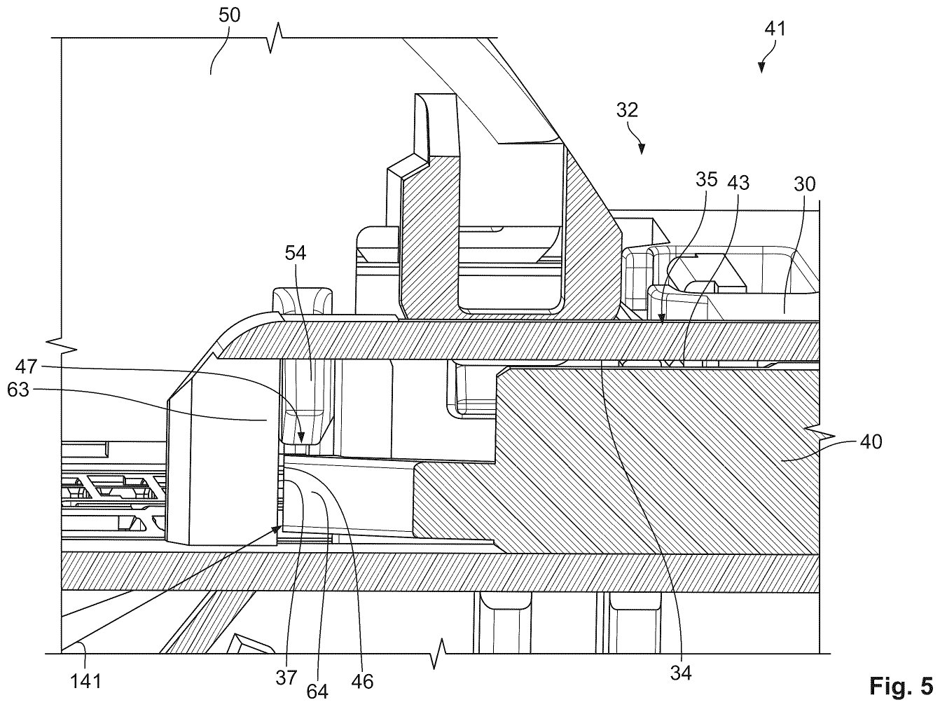

FIG. 6 shows a schematic partially sectional side view of the embodiments of FIGS. 1 to 5 with the sectional plane being different from the one in FIG. 5.

### DETAILED DESCRIPTION OF THE INVENTION

The figures show an exemplary embodiment of an assembly 101 for a connector 100. The depicted connector 100 is only exemplarily shown as an electric connector 100. Other types of connectors 100, for example fiberglass connectors, can also be improved with the shown solutions.

The assembly 101 comprises a housing part 20 that can serve as a base element, a support element and/or a protection element for further parts of the assembly 101. The housing part 20 in particular comprises terminal block receptacles 21 adapted for the insertion of terminal blocks 85. In the described embodiment, four different types of terminal blocks 85 are used, each having a coding element 86 protruding sideways (i.e. along a second transverse direction T2) at a different location along a first transverse direction T1. Consequently, only suitable terminal blocks 85 can be inserted into each terminal block receptacle 21. Terminals (not depicted) can be inserted into terminal receptacles in the terminal blocks 85. In other embodiments, terminals could be inserted directly into terminal receptacles in the housing part 20.

The terminal blocks 85 can be inserted into the housing part 20 along an insertion direction I, which is in the depicted example parallel to a connection direction C along which the connector 100 is mated with a mating connector 200. The mating connector 200 here is shown only schematically with a housing part 220.

The assembly 101 further comprises a cover 50 that can be attached or mounted to the housing part 20 once the terminal blocks 85 with the attached terminals and cables have been inserted into the housing part 20. The cover 50 is mounted along a mounting direction M, which in the described example is parallel to the insertion direction I and the connection direction C. An opening allowing the exiting of cables from a receptacle defined by the cover 50 is open sideways in the mounted state 51.

The cover 50 comprises latching elements 52, which, in a mounted state 51 of the cover 50, engage corresponding latching elements 25 in the form of protrusions 26 on the housing part 20 and thus secure the cover 50 relative to the housing part 20.

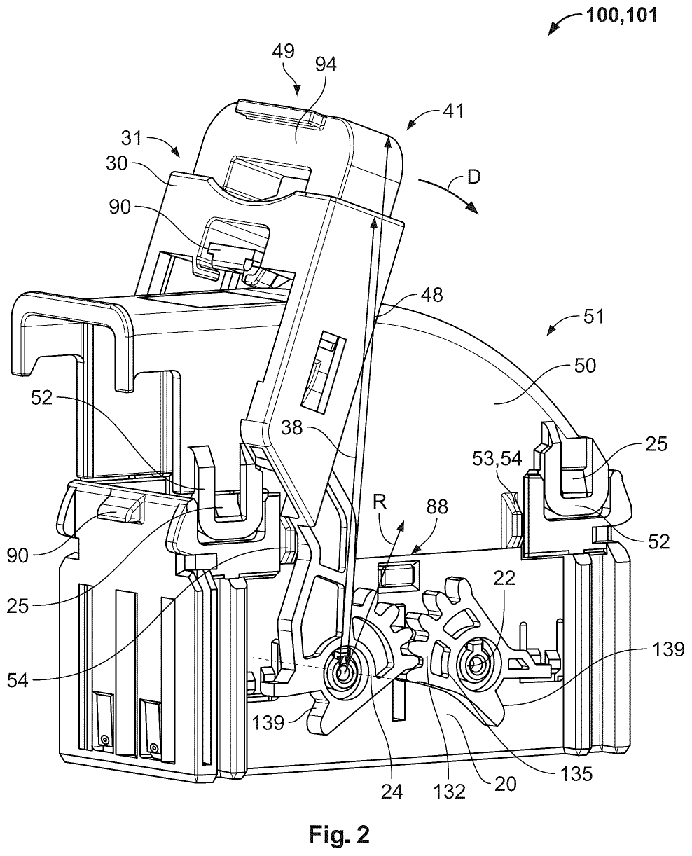

A lever 30 of the assembly 101 is part of a securing mechanism 120 for securing the connector 100 on the mating connector 200 and part of a pulling mechanism 130 for pulling the connector 100 into or onto the mating connector 200. The lever 30 comprises at receptacle 139 for engaging a non-depicted counter element or mating element on the mating connector 200. In a starting position 31 of the lever 30 (for example shown in FIG. 2), the counter element can be inserted into the receptacle 139. The lever 30 can then be rotated along a rotation direction D that is tangential to a rotation axis 24 towards a final position 32 of the lever 30. In this final position 32, the receptacle 139 and the counter element are positively locked along the connection direction C.

The lever 30 rotates about the rotation axis 24 that runs centrally through an axle 22 formed by the housing 20. The axle 22 is configured as a short pin 23 that protrudes sideways along the second transverse direction T2 away from the rest of the housing part 20 and is located in a corresponding recess of the lever 30, when the lever 30 is attached to the housing part 20. The pin 23 and the hole in the lever are shaped as a key and a key hole to allow a mounting in one orientation and to block a movement of the lever 30 away from housing part 20 in the second transverse direction T2 outside the one position.

The lever 30 comprises a toothed wheel section 132 for transmitting the movement to a further element 135 that also secures the connector 100 to the mating connector 200. The further element 135 also comprises a receptacle 139 and a toothed wheel section 132 and rotates about a further axle 22 formed by the housing 20.

The assembly 101 comprises a lever lock 40 that is adapted for blocking a rotation of the lever 30 out of the final position 32 when the lever lock 40 is in a locking position 42 and that allows a rotation of the lever 30 when the lever lock is 40 is in a release position 41. The lever lock 40 cannot be moved freely from the release position 41 to the locking position 42. During normal operation, it can only be moved into the locking position 42 when the lever 30 is in the final position 32 and the cover 50 is in the correctly mounted position or state 51.

In particular, the assembly 101 comprises a pair of engaging translational blocking members 63, 64 on the lever 30 and the lever lock 40, respectively. If at least one of the two conditions is not fulfilled, that is, if the lever 30 is not in the final position 32 and/or the cover 50 is not in the mounted state 51, a stop face 46 located on the outermost part or front face of the free end 47 of an arm 44 of the lever lock 40 abuts a stop face 37 on the lever 30. To disengage the two translational blocking members 63, 64, the cover 50 forms a release element 54 configured as a protrusion 53, that elastically deflects the free end 47 of the arm 44, when the cover 50 is in the mounted state 51. In the depicted embodiment, the blocking member 63 is located on a dedicated subsection of the arm 44 that is thinner than and inclined relative to the rest of the arm 44.

The release element 54 is formed as an elongated protrusion 53 that protrudes along the second transverse direction T2 away from the rest of the cover 50 and extends along the mounting direction M of the cover 50. The mounting direction M is parallel to the connection direction C to maintain the same direction for assembly during the entire assembling procedure.

In the advantageous embodiment shown here, the cover 50 indeed comprises four similar release elements 54. These are pairwise equivalent to each other with respect to a 180° rotation, and pairwise mirror-symmetric to each other. Thus, the cover 50 and the lever 30 can be attached to or mounted on the housing part 20 in various orientations while having at least one release element 54 in an appropriate position in each orientation.

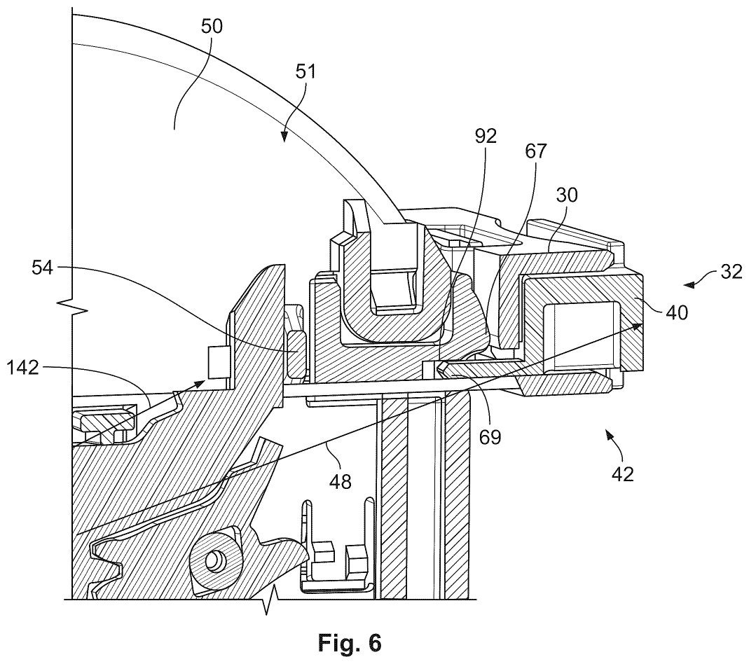

To improve the safety further, the assembly 101 comprises further translational blocking members 67, 69 located on the housing 20 and the lever lock 40, respectively. These further translational blocking members 67, 69 in particular help avoid an undesired movement of the lever lock 40 if the cover 50 is close to, but not in the mounted state 51 and the lever 30 is close to but not in the final position 32. As can be seen, for example in FIG. 6, blocking by the further translational blocking member 67 of the housing 20 and the further translational blocking member 69 of the lever lock 40 is only lifted when the lever 30 is in the final position 32. Only in the final position 32, a can the blocking member 66 that comprises the further translational blocking member 69 of the lever lock 40 be inserted into a receptacle 92 on the housing 20. The further pair of translational blocking members 67, 69 is spaced from the first pair of blocking members 63, 64 in a radial direction R. “Radial direction R” refers to a bundle of directions that are perpendicular to the rotation axis 24.

The blocking by the further pair of blocking members 67, 69 is independent of the status of the cover 50, i.e. whether the cover 50 is mounted correctly or not. In the depicted example, the cover 50 can be mounted when the lever is in the final position 32 and the lever 30 can be moved into the final position 32 when the cover 50 is mounted. This allows flexibility in the assembling process. In alternative embodiments, only one of the two mounting sequences and can be possible, for example in order to increase safety.

Once the blocking by the translational blocking members 63, 64, 67, 69 is lifted or cancelled, the lever lock 40 can be moved manually or by a machine from the release position 41 into the locking position 42. A rotation of the lever 30 relative to the housing part 20 is blocked indirectly in the locking position 42 with the lever lock 40 acting as an intermediate element. Rotational blocking members 72 on the housing 20 engage rotational blocking members 74 on the lever lock 40. A rotation of the lever 30 relative to the lever lock 40 is in turn not possible due to a positive fit between the two, namely by engagement of guiding faces 34, 43 on the lever 30 and the lever lock 40, respectively. The guiding faces 34, 43 together form a guiding device 35 that allows a guided sliding of the lever lock 40 relative to the lever 30 in a translational manner.

The rotational blocking member? 74 of the lever lock 40 is part of the blocking member 66 that also forms the translational blocking member 64. The blocking member 66 is configured as a board shaped protrusion that protrudes inwardly to save space. It forms a corner of the lever lock 40. At the blocking member 66, the thickness of the lever lock 40 is considerably lower than at the adjacent sections.

The lever 30 and the lever lock 40 are separate elements that can be made from different materials depending on the desired functionality.

A distance 142 of the lever lock 40 to the rotation axis 24 in the locking position 42 is shorter than a distance 141 of the lever lock 40 to the rotation axis 24 in the release position 41. Thus, the connector 100 is more compact in the locking position 42, which is usually the position in which the lever lock 40 is in the final product and during normal operation of the connector 100. In other configurations, this can be the other way round or the distance can stay the same in the two positions 41, 42.

During a rotation of the lever 30 relative to the housing part 20, a distance of the lever lock 40 to the rotation axis 24 of the lever 30 is constant. During this rotation, the lever lock 40 stays in the release position 41.

In the depicted embodiment, the lever lock 40 acts as an extension part 95 for the lever 30 when in the release position 41. The extension part 95 extends the lever length. In the release position 41, a length 48 from the rotation axis 24 to the outermost or distal end 49 of the lever lock 40 is longer than a length 38 from the rotation axis 24 to the outermost or distal end 39 of the lever 30. In the locking position 42, the difference in the lengths 38, 39 is smaller, almost zero.

An actuation section 94 that is configured for the actuation by a human or machine is located at the lever lock 40.

The assembly 101 comprises a further or second lever lock 80 for blocking a movement of the lever 30 out of the final position 32. The second lever lock 80 is shaped as a beam or a bar that is held slidable parallel to the rotation axis 24 in a complementary elongated receptacle in the housing part 20. It is adapted to be operated by moving it along an actuation direction A parallel to the rotation axis 24 from a locking position 89, in which it locks the lever 30 in the final position 32, to a release position 89, in which its blocking effect on the lever 30 is not present. In the locking position 89, a rotational blocking member 81 on the second lever lock 80 blocks a movement of a corresponding blocking member 83 on the lever 30. In each case, sections of the second lever lock 80 and the lever 30 act as the blocking members 81, 83 to keep the design simple. The fact that the actuation direction A and the locking direction L of the (first) lever lock 40 are perpendicular reduces that risk of an unintentional or accidental release, which could for example be effected by vibrations.

The second lever lock 80 is separate from the (first) lever lock 40 and located closer to the rotation axis 24. This takes account of the fact that the second lever lock 80 is used to keep the lever 30 in the final position 32 when the terminal blocks 82 are being inserted but the connector 100 is not yet mated with the mating connector 200. At this stage, the forces are still low and a securing by only the second lever lock 80 is possible. Once all the parts of the connector 100 including the cover 50 are mounted, the connector 100 can be mated with the mating connector 200. The forces that are acting at this stage are higher so that the location of the (first) lever lock 40 further away from the rotation axis 24 is advantageous due to the law of the lever. At this stage, bringing the second lever lock 80 into the locking position 89 is not necessary. Rather, it can be used to secure the terminal blocks 85 in their correct positions within the housing part 20, as will the described in the following.

The further lever lock 80 can affect the insertability of the terminal blocks 85 into the receptacles 21 in the housing part 20. For example, a full insertion can only be possible when the second lever lock 80 is in the locking position 89. In turn, the terminal blocks 85 can block a movement of the second lever lock 85 back into the release position 88 if they are inserted incorrectly or insufficiently deep. Once they reach their desired insertion depth, the movement of the second lever lock 80 can be enabled or cleared.

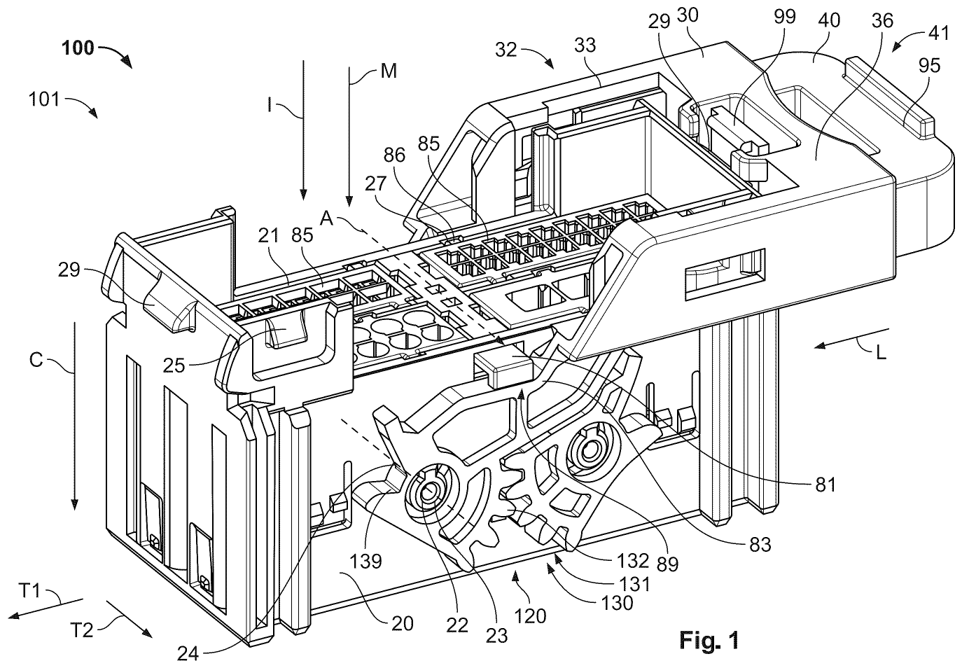

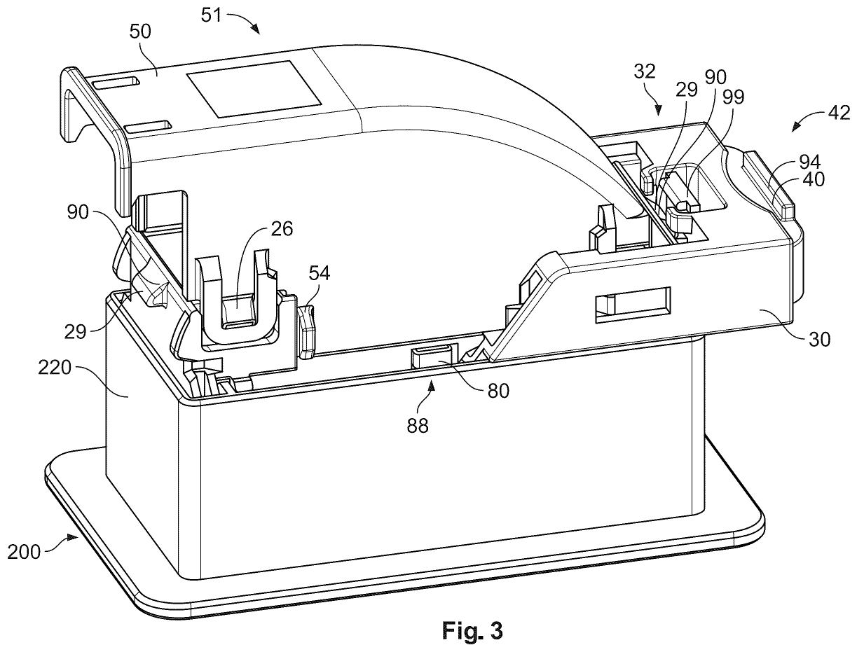

As can be seen in FIGS. 1 and 3, the further lever lock 80 is adapted to block mating of the connector 100 with a mating connector 200 when in the locking position 89. It protrudes from the housing part 20, when outside the release position 88. In the locking position 89, it protrudes to such an extent that it blocks an insertion of the connector 100 into the housing part 220 of the mating connector 200.

The exemplary embodiment shown here comprises a third lever lock 90, which, like the first lever lock 40 blocks a movement of the lever 30 in the final position thereof. A deflectable latching arm 99 on the lever 30 automatically latches behind a corresponding latching element 29 formed as a wedge shaped protrusion 28 on the housing part 20. Unlike the first and the second lever locks 40, 80, the third lever lock 90 thus creates a direct connection (without intermediate elements) between the lever 30 and the housing part 20. This can reduce the tolerances or hysteresis due to the reduced number of involved parts. Further, the third lever lock 90 can lock the lever 30 before the lever lock 40 is moved into the locking position 42.

Both the lever 30 and the lever lock 40 have the shape of a U. Two arms 33, 44 are connected by a bridging section 36, 45.

The lever 30, the lever lock 40, the cover 50 and the housing part 20 are mirror symmetric to achieve an advantageous symmetrically balanced force flow.

Although not depicted here, the lever lock 40 could also be mirror symmetric relative to a second mirror plane that is perpendicular to a mirror plane of the first mirror symmetry. The resulting lever lock 40 could then be invariant to a rotation around 180 degrees. This would simplify the assembling process further, as the lever lock 40 could be mounted in two equivalent rotational orientations, making an orientation step for the assembling person superfluous. However, it might be necessary to adapt the other parts 20, 30 of the connector 100 to such an amended lever lock 40.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Assembly for a connector, the assembly comprising:
a housing part;
a cover adapted to be mounted to the housing part;
a lever adapted to be attached to the housing part and that can be rotated from a starting position to a final position relative to the housing part when attached; and
a lever lock that blocks the rotation of the lever out of the final position when the lever lock is in a locking position, and that allows a rotation of the lever when the lever lock is in a release position;
wherein the lever lock can only be moved from the release position to the locking position when the lever is in the final position and the cover is mounted on the housing part.

2. Assembly according to claim 1, wherein a movement of the lever lock into the locking position is blocked by a pair of engaging translational blocking members on the lever and the lever lock, respectively.

3. Assembly according to claim 2, wherein the cover comprises a release element for disengaging the two translational blocking members when the lever is in the final position and the cover is mounted on the housing part.

4. Assembly according to claim 3, wherein the release element is elongated in a connection direction of the connector.

5. Assembly according to claim 3, wherein the cover comprises a further release element.

6. Assembly according to claim 2, wherein the translational blocking member of the lever lock is located at a free end of the lever lock.

7. Assembly according to claim 2, wherein a movement of the lever lock into the locking position is blocked by a further pair of engaging translational blocking members on the lever lock and the housing part, respectively, when the lever is close to but not in the final position, wherein the further pair is spaced from the first pair in a radial direction.

8. Assembly according to claim 7, wherein the blocking by the further pair of translational blocking members is independent of the status of the cover.

9. Assembly according to claim 1, wherein the cover is configured to be mounted when the lever is in the final position and the lever is configured to be moved into the final position when the cover is mounted.

10. Assembly according to claim 1, wherein a distance of the lever lock to the rotation axis of the lever is shorter in the locking position than in the release position.

11. Assembly according to claim 1, wherein the lever lock acts as an extension part for the lever when in the release position.

12. Assembly according to claim 1, wherein the lever lock and the housing part comprise a pair of engaging rotational blocking members for blocking a rotation of the lever out of the final position when the lever lock is in the locking position.

13. Assembly according to claim 1, wherein:
a movement of the lever lock into the locking position is blocked by a pair of engaging translational blocking members on the lever and the lever lock, respectively;
wherein a movement of the lever lock into the locking position is blocked by a further pair of engaging translational blocking members on the lever lock and the housing part, respectively, when the lever is close to but not in the final position, wherein the further pair is spaced from the first pair in a radial direction; and
wherein the lever lock and the housing part comprise a pair of engaging rotational blocking members for blocking a rotation of the lever out of the final position when the lever lock is in the locking position; and

14. Assembly according to claim 13, wherein the lever lock comprises a blocking member that forms one of the further pair of engaging translational blocking members and one of the engaging rotational blocking members.

15. Assembly according to claim 1, wherein the assembly comprises at least one further lever lock for blocking a movement of the lever out of the final position.

16. Assembly according to claim 15, wherein the further lever lock is adapted to block mating of the connector with a mating connector when in a locking position.

17. Assembly for a connector, the assembly comprising:
a housing part;
a cover adapted to be mounted to the housing part;
a lever adapted to be attached to the housing part and that can be rotated from a starting position to a final position relative to the housing part when attached; and
a lever lock that blocks the rotation of the lever out of the final position when the lever lock is in a locking position, and that allows a rotation of the lever when the lever lock is in a release position;
wherein the lever lock can only be moved from the release position to the locking position when the lever is in the final position and the cover is mounted on the housing part; and
wherein a movement of the lever lock into the locking position is blocked by a first pair of engaging translational blocking members on the lever and the lever lock, respectively; and
wherein a movement of the lever lock into the locking position is blocked by a second pair of engaging translational blocking members on the lever lock and the housing part, respectively, when the lever is close to but not in the final position.

18. Assembly according to claim 17, wherein the second pair of engaging translational blocking members is spaced from the first pair of engaging translational blocking members in a radial direction.

19. Assembly according to claim 17, wherein the lever lock and the housing part comprise a pair of engaging rotational blocking members for blocking a rotation of the lever out of the final position when the lever lock is in the locking position.

20. Assembly for a connector, the assembly comprising:
a housing part;
a cover adapted to be mounted to the housing part;
a lever adapted to be attached to the housing part and that can be rotated from a starting position to a final position relative to the housing part when attached; and
a lever lock that blocks the rotation of the lever out of the final position when the lever lock is in a locking position, and that allows a rotation of the lever when the lever lock is in a release position;
wherein the lever lock can only be moved from the release position to the locking position when the lever is in the final position and the cover is mounted on the housing part; and
wherein a movement of the lever lock into the locking position is blocked by a pair of engaging translational blocking members on the lever and the lever lock, respectively; and
wherein the lever lock and the housing part comprise a pair of engaging rotational blocking members for blocking a rotation of the lever out of the final position when the lever lock is in the locking position.
